(19) United States
(12) Patent Application Publication
(10) Pub. No.: US 2026/0157275 A1
(43) Pub. Date: Jun. 11, 2026

(54) Combine Harvester Control System

(71) Applicant: AGCO International GmbH, Neuhausen Am Rheinfall (CH)

(72) Inventors: Andreas Rye Andersen, Randers (DK); Alastair Cameron Morrison, Randers (DK)

(21) Appl. No.: 19/415,735

(22) Filed: Dec. 10, 2025

(30) Foreign Application Priority Data
Dec. 11, 2024 (GB) 2418188.5

(51) Int. Cl. A01D 41/127

(52) U.S. Cl. CPC A01D 41/1276

(57) ABSTRACT

A method of controlling a flow of crop material through a grain cleaning unit includes the steps of generating a first cleaning airstream directed through upper and lower sieves and a second cleaning airstream directed through a precleaning sieve by a fan, measuring an air pressure determined by air pressure sensors at a plurality of locations within the grain cleaning unit, determining by a controller coupled to the air pressure sensors and first, second and third actuators and operable to control operation of the first, second and third actuators, any desired variation to the second cleaning airstream, and generating a signal from the controller to adjust the speed of the fan and generating a signal from the controller also to control operation of the first actuator to adjust the position of the louvres of the precleaning sieve accordingly.

### CROSS-REFERENCE TO RELATED APPLICATIONS

This application claims the benefit of the filing date of U.K. Patent Application 2418188.5, “Combine Harvester Control System,” filed Dec. 11, 2024, the entire disclosure of which is incorporated herein by reference.

### FIELD

The present invention relates to the processing of a crop stream in a combine harvester, in particular to the processing of a crop stream in a grain cleaning unit of a combine harvester and to a combine harvester incorporating a suitable grain cleaning unit.

### BACKGROUND

For many decades, self-propelled combine harvesters have been used by farmers to harvest a wide range of crops including cereals, maize and oil-seed rape. Typically, a combine harvester cuts the crop material, threshes the grain (or seed) therefrom, separates the grain from the straw, and cleans the grain before storing the cleaned grain in an on-board tank. Straw and crop residue is ejected from the rear of the machine.

Combine harvesters typically have a threshing and separating apparatus arranged to convey a cut crop stream in a generally rearward direction. A threshing cylinder rotating on a transverse axis conveys the crop stream tangentially underneath. Grain dislodged from the crop stream falls through a concave grate onto an underlying oscillating pan, hereinafter termed a stratification pan.

The remaining crop stream is conveyed to the separating apparatus which, in this case, comprises a pair of axial separating rotors. Grain and material other than grain (MOG) falls through a grate arrangement disposed under the rotors onto an oscillating return pan which conveys the grain and MOG forwardly to a front edge from where it falls onto the stratification pan.

The grain and MOG collected by the stratification pan is conveyed rearwardly by the oscillating motion, to a rear edge from where it transfers to a cleaning unit having a plurality of sieves and the like.

Agricultural combines typically include a grain cleaning unit below and rearward of the threshing unit. The grain cleaning unit includes a cleaning fan oriented horizontally and transversely across the combine to create airflow through one or more sieves.

Controlling the air speed in a grain cleaning unit is a balance between either too little air velocity (in which case the system will not effectively blow out the chaff) and too much air velocity (in which case the system will blow out the grain).

Current grain cleaning units use a cascade to blow the initial bulk of the chaff away from the grain. There are two limitations associated with this, firstly, by increasing the airspeed in the cascades, the airspeed coming through the rest of the system is also increased which means that it is difficult to optimise the exact airspeed needed in both the cascade and the chaffer at the same time. Secondly, the cascade system is limited by the acceleration of the grain due to gravity.

It is therefore desirable to utilise a grain cleaning unit enabling more controlled airflow through the grain cleaning unit, in particular being able to vary the airflow to allow for more capacity to separate the chaff from the grain before the grain reaches the chaffer and to allow for different types of grain (or seed) as the combine harvester is used to harvest different kinds of crop.

### BRIEF SUMMARY

According to a first aspect of the present invention, a method of controlling a flow of crop material through a grain cleaning unit incorporating a precleaning sieve having adjustable louvres adjustable by a first actuator, an upper sieve having adjustable louvres adjustable by a second actuator and a lower sieve having adjustable louvres adjustable by a third actuator, comprises the steps of
generating a first cleaning airstream directed through the upper and lower sieves and a second cleaning airstream directed through the precleaning sieve by a fan,
measuring an air pressure determined by air pressure sensors at a plurality of locations within the grain cleaning unit,
determining by a controller coupled to the air pressure sensors and the first, second and third actuators and operable to control operation of the first, second and third actuators, any desired variation to the second cleaning airstream, and
generating a signal from the controller to adjust the speed of the fan and generating a signal from the controller also to control operation of the first actuator to adjust the position of the louvres of the precleaning sieve accordingly.

Preferably, the method further includes the further steps of
again measuring an air pressure determined by the air pressure sensors at the plurality of locations within the grain cleaning unit,
determining by the controller any further desired variation to adjust the second cleaning airstream and
generating a signal from the controller to control operation of the first actuator to adjust further the position of the louvres of the precleaning sieve accordingly.

Preferably, the method further includes the further steps of
once again measuring an air pressure determined by the air pressure sensors at the plurality of locations within the grain cleaning unit,
determining by the controller any further desired variation to adjust the first cleaning airstream and
generating signals from the controller to control operation of one or both of the second and third actuators to adjust the position of the louvres of the upper and lower sieves accordingly.

According to a second aspect of the present invention a combine harvester comprises
a threshing apparatus,
a separating apparatus,
a grain cleaning unit located downstream of the separating apparatus,
wherein the grain cleaning unit comprises
   a precleaning sieve having louvres adjustable by a first actuator,
   upper and lower sieves having louvres adjustable by respective second and third actuators,
   a fan to generate each of a first cleaning airstream directed through the upper and lower sieves and a second cleaning airstream directed through the precleaning sieve, and
   air pressure sensors located at a plurality of locations within the grain cleaning unit to sense air pressure at each of the plurality of locations and to generate signals indicative of the air pressure,
wherein a controller is configured to control operation of the fan to control the second cleaning airstream based upon the signals from the air pressure sensors and to control operation of the first actuator to adjust the position of the louvres of the precleaning sieve.

Preferably, the controller is configured also to control operation of the first second and third actuators to adjust the position of the louvres of each of the upper and lower sieves based upon the signals from the air pressure sensors.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a schematic side elevation view of an example combine harvester showing the outline of the combine harvester in ghost form;

FIG. 2 shows vertical section through an example combine harvester of showing the return pan and grain cleaning unit;

FIG. 3 shows a schematic diagram of the system for controlling air flow in the grain cleaning unit;

FIG. 4 shows a first example process for operating the grain cleaning unit of FIG. 2: and

FIG. 5 shows a second example process for operating the grain cleaning unit of FIG. 2.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

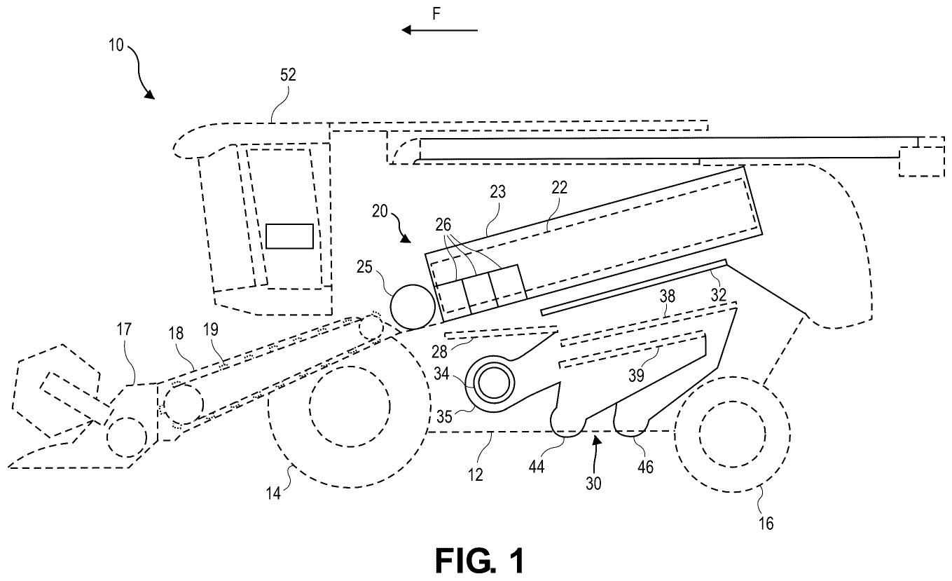

Relative terms such as forward, rearward, transverse, lateral, longitudinal and sideways will be made with reference to the normal forward direction of travel of the combine harvester 10 and indicated by arrow F represented in FIG. 1. The terms vertical and horizontal will be made with reference to the level ground 101 upon which the combine 10 is disposed. In other words the Cartesian axes of ‘longitudinal’, ‘transverse’, and ‘vertical’ are made in relation to the frame 12 of combine 10 and are not affected by any slope in the ground. The terms “upstream” and “downstream” are made with reference to the general direction of crop flow along the material conveyance systems described.

It should be understood that positional terms such as ‘front’, ‘rear’, ‘forward’ and ‘backward’ are made with reference to the forward direction of travel of the combine harvester wherein a cutterbar is typically located at the front and the crop residue is ejected at the rear. References to ‘upstream’ and ‘downstream’ are made with reference to the moving stream of cut crop material and grain as it passes through the combine harvester.

FIG. 1 illustrates in schematic form the main components of the crop processing system of a combine harvester 10 and will be used to explain the flow of material below. An example crop processing system is shown in solid lines whilst the outline profile of harvester 10 is shown in broken lines.

With reference to FIG. 1 a combine harvester 10 includes a frame or chassis 12, front wheels 14 and rear steerable wheels 16. A cutting header 17 that cuts and gathers a strip of crop as the combine harvester 10 is driven across a crop field is detachably supported on the front of a feederhouse 18 which is pivotable about a transverse axis to lift and lower the header 17 in a conventional manner.

The combine harvester 10 also includes an operator cab 52 within which is conveniently located a user terminal 54 which an operator may use to direct operation of the combine harvester 10. The user terminal 54 comprises a display which may be integrated as part of a terminal having user interface devices such as buttons, levers and switches. The user terminal 54 is mounted proximate to a drivers workstation in the operator cab 52. The user terminal 54 is in electronic communication with an electronic control unit 56 itself in electronic communication with various operational components of the combine harvester 10.

The combine harvester 10 is driven in a forward direction F across a field of standing crop in a known manner. The header 17 serves to cut and gather the crop material before conveying such into feederhouse 18 and an elevator 19 housed therein. At this stage the crop stream is unprocessed. It should be understood that combine harvesters are employed to harvest a host of different crops including cereal, rice, beans, corn and grass seed (herein “grain”). The following description will make reference to various parts of the cereal crop stream but it should be understood that this is by way of example only and does not by any means limit the applicability of the invention to harvest other crops.

The cut crop stream is conveyed rearwardly from the feederhouse 18 to a processor designated generally at 20. In the illustrated embodiment the processor 20 is of the axial rotary type having a pair of axial-flow threshing and separating rotors 22 which are each housed side-by-side inside a respective rotor housing 23 and are fed at their front end by a feed beater 25. It should be appreciated that the right-hand rotor is hidden from view in FIG. 1. The rotors serve to thresh the crop stream in a front ‘threshing’ region, separate the grain therefrom in a rear ‘separating’ region, and eject the straw residue through the rear of the machine either directly onto the ground in a windrow or via a straw chopper (not shown).

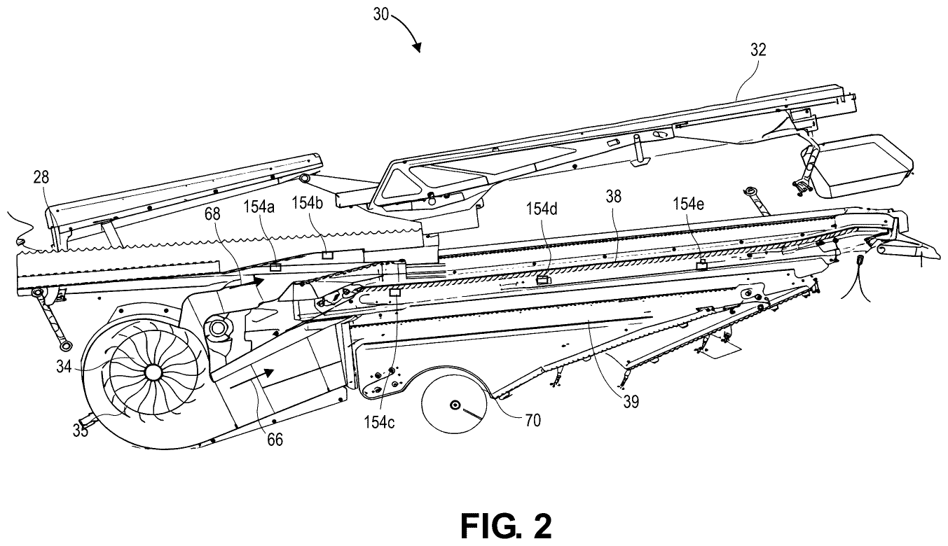

Each rotor housing 23 is generally cylindrical and is made up of an opaque upper section and a foraminous lower section which includes a set of side-by-side arcuate concave grate segments 26 extending the length of the front threshing region and which allow the threshed material to fall by gravity onto a stratification pan 28 located below for onward conveyance to a grain cleaning unit which is designated generally at 30. Guide vanes (not shown) are secured to the inside of the rotor housing and serve, in conjunction with the crop engaging elements on the rotor 22, to convey the stream of crop material in a generally rearward spiral path from front to rear. As shown in more detail in FIG. 2, a precleaning sieve 29 is provided at a rear edge of the stratification pan 28.

The separating region at the rear portion of rotors 22 comprises plural crop engaging elements (not shown) to separate the residual grain from the stream of crop material. A grain return pan 32 is provided underneath the separating region to collect the separated grain and convey it forwardly for delivery onto the stratification pan 28. Both the stratification pan 28 and return pan 32 are driven with a drive mechanism so as to oscillate in a known manner.

Although described as a rotary axial type, the processor 20 may be of an alternative type such as known conventional, hybrid or transverse types without departing from the scope of the invention. For example, in the case of a conventional type processor, a transverse cylindrical beater may be provided as threshing apparatus and a set of straw-walkers provided as separating apparatus.

With particular reference to FIG. 2, the grain cleaning unit 30 comprises a single fan 34 housed in a fan housing 35. The fan 34 may be of a known type such as a crossflow or centrifugal fan that rotates on a transverse axis and draws in air either tangentially or axially through air intake openings.

The grain cleaning unit 30 further comprises screening apparatus which includes a shoe frame (not shown), upper sieve 38 (alternatively referenced ‘chaffer’) and a lower sieve 39. The sieves 38, 39 are driven with an oscillating motion in a known manner. The sieves 38, 39 are mounted between side members of the shoe frame which is suspended on hangers (also not shown) from the frame 12 and driven in an oscillating motion.

The sieves 37,38,39 each comprise a plurality of transverse louvres which can be adjusted either manually or remotely to adjust the coarseness of the screen provided. The louvres are arranged in a parallel transverse relationship and pivot to adjust the opening or gap between adjacent ones. First, second and third actuators 60,62,64 (FIG. 3) are provided to allow remote adjustment of the transverse louvres.

The fan 34 is used to generate two cleaning airstreams: a first airstream (indicated by arrow 66) exhausted from the fan housing 35 towards the chaffer 38 and the lower sieve 39 and a second airstream (indicated by arrow 68) directed under the stratification pan 28 and through precleaning sieve 37. In an alternative example separate fan units may be used to generate each of the first cleaning airstream and the second cleaning airstream.

The threshed material, comprising a mixture of grain and MOG, is conveyed by the stratification pan 28 in a rearward direction until it passes over the precleaning sieve 37 onward to the sieves 38,39. The cleaning airstreams are directed through and over the sieves 37,38,39 in a known manner so as to lift the lighter material, primarily MOG, away from the surface of the precleaning sieve 37 and the upper sieve 38 and in a rearward direction for ejection at a rear outlet 42. The first cleaning airstream creates a pressure differential across the sieves 38,39 to encourage lighter MOG rearwardly and upwardly whilst allowing the grain to pass through the sieves 38,39. The second cleaning airstream passes above upper sieve 38 and below the precleaning sieve 37 thus acting upon the crop stream as it falls from a rear edge of the stratification pan 28 towards the chaffer.

In a known manner, the screening apparatus 36 is operable to allow the clean grain to pass through the sieves 37,38, 39, wherein the clean grain is collected in a transverse clean grain trough 44 and conveyed onwards to an on-board grain tank (not shown). The louvres of precleaning sieve 37 and upper sieve 38 may be set to allow unthreshed heads to pass through a rear region of the upper sieve 38 into a tailings collection trough 46. Likewise, any material screened out by lower sieve 39 falls from the rear edge thereof into the tailings collection trough 46 from where the ‘returns’ are fed back to the processor 20 or a dedicated rethreshing system (not shown) by way of an auger 70.

It will be appreciated that within the confines of the cleaning shoe there is some interaction of the first and second cleaning airstreams. This creates an additional problem in addition to controlling the cleaning airstreams in order to optimise blowing out the chaff, while optimising retention of the harvested grain.

A number of air pressure sensors 154a,154b,154c,154d,154e are located in the cleaning shoe. In the illustrated example, five such sensors are shown. Other numbers of sensors may be used. In their respective locations, the air pressure sensors 154a,154b,154c,154d,154e output information representative of the local static air pressure.

With reference to FIG. 3 the electronic control unit 56 is, as noted above, in electronic communication with various operational components of the combine harvester 10, including the user terminal 54 in the operator cab 52, each of the sensors 154a,154b,154c,154d,154e and each of the actuators 60,62,64. Typically, the electronic control unit 56 is also in electronic communication with other operational aspects of the combine harvester 10 such as the fan 34, a ground speed controller (not shown) and a rotor speed controller (not shown).

The electronic control unit 56 is also in electronic communication with a memory unit 58. The memory unit 58 may store a native operating system, one or more native applications, emulation systems, emulated applications for any of a variety of operating systems and/or emulated hardware platforms, emulated operating systems etc.

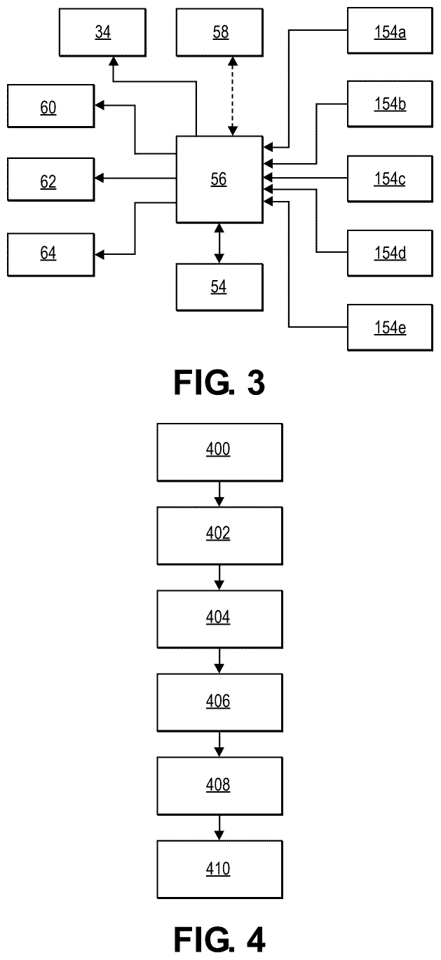

In use, the first and second cleaning airstreams 66,68 are generated to create air pressure within the grain cleaning unit 30. The air pressure sensors 154a,154b,154c,154d,154e output signals corresponding to information representative of the local static air pressure detected to the electronic control unit 56 (step 400, FIGS. 4 & 5). The electronic control unit 56 determines a desired static air pressure at these locations, for example, by comparing the received output signals with optimal values within a stored look-up table (step 402). A high level of static pressure in the grain cleaning unit will limit the performance of the grain cleaning unit.

The electronic control unit 56 subsequently (step 404), as required, outputs a signal operable to control the fan 34 as a function of the detected static air pressure values to vary the first and second air cleaning streams 66,68 in order to cause the static air pressure values detected by the air pressure sensors 154a,154b,154c,154d,154e to more closely approach the stored optimal values. In this way an optimal initial separation of the grain and MOG can be obtained from the precleaning sieve 37, while maintaining an optimal cleaning airstream around the upper and lower cleaning sieves 38,39 as the crop flow progresses through the grain cleaning unit 30. In this step the electronic control unit 56 may also output a signal to control the first actuator 60 maintaining the louvre positions in the precleaning sieve 37. For example, if the fan 34 adjusts to 1000 rpm, the electronic control unit 56 outputs a signal to adjust the louvre setting of the precleaning sieve to 5 mm.

The electronic control unit 56 then determines again a desired static air pressure at the sensor locations, for example, by comparing the received output signals with the optimal values within a stored look-up table (step 406). As a result of this comparison, the electronic control unit 56 may output a further signal to control the first actuator maintaining the louvre positions in the precleaning sieve 37 (step 408). For example, the electronic control unit 56 outputs a signal to the first actuator 60 to adjust the louvre setting of the precleaning sieve 37 by +/−2 mm.

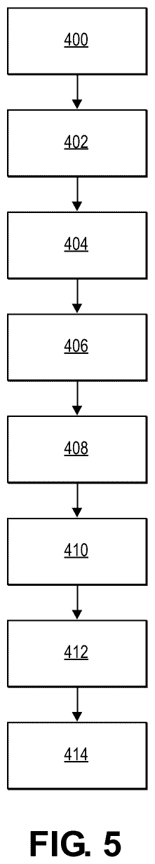

In a further example (FIG. 5), the previous steps are followed. The electronic control unit 56 once again detects the received output signals from the air pressure sensors 154a,154b,154c,154d,154e (step 410) and compares these with the optimal values within a stored look-up table (step 412). As a result of this comparison, the electronic control unit 56 may output further signals to control the second and third actuators maintaining the louvre positions in the upper and lower cleaning sieves 38,39 (step 414).

It will be understood that different lookup tables can be stored each including differing values for the optimal air pressure at different locations within the cleaning shoe depending upon the crop being processed. For example, an operator may select a particular crop kind from the user terminal 54 to direct the electronic control unit 56 to select the optimal values from an appropriate stored look up table. The electronic control unit 56 can generate signals to the user terminal 54 to display information to an operator relating to operation of the grain cleaning unit 30.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of combine harvesters and component parts therefore and which may be used instead of or in addition to features already described herein.

What is claimed is:

1. A method of controlling a flow of crop material through a grain cleaning unit incorporating a precleaning sieve having adjustable louvres adjustable by a first actuator, an upper sieve having adjustable louvres adjustable by a second actuator, a lower sieve having adjustable louvres adjustable by a third actuator, comprises the steps of
generating by a fan a first cleaning airstream directed through the upper and lower sieves and a second cleaning airstream directed through the precleaning sieve,
measuring an air pressure determined by air pressure sensors at a plurality of locations within the grain cleaning unit,
determining by a controller, coupled to the air pressure sensors and the first, second and third actuators and operable to control operation of the first, second and third actuators, any desired variation to a position of the louvres of the precleaning sieve, and
generating a signal from the controller to adjust the speed of the fan and generating a signal from the controller to control operation of the first actuator to adjust the position of the louvres of the precleaning sieve accordingly.

2. A method of controlling a flow of crop material through a grain cleaning unit, according to claim 1, further including the steps of
again measuring an air pressure determined by the air pressure sensors at the plurality of locations within the grain cleaning unit,
determining any further desired variation to adjust the second cleaning airsteam, and
generating a signal from the controller to control operation of the first actuator to adjust further the position of the louvres of the precleaning sieve accordingly.

3. A method of controlling a flow of crop material through a grain cleaning unit according to claim 1, further including the step of
once again measuring an air pressure determined by the air pressure sensors at the plurality of locations within the grain cleaning unit,
determining by the controller any further desired variation to adjust the first cleaning airsteam, and
generating signals from the controller to control operation of one or both of the second and third actuators to adjust the position of the louvres of the upper and lower sieves accordingly.

4. A combine harvester comprising
a threshing apparatus,
a separating apparatus,
a grain cleaning unit located downstream of the separating apparatus,
wherein the grain cleaning unit comprises
a precleaning sieve having louvres adjustable by a first actuator,
upper and lower sieves having louvres adjustable by respective second and third actuators,
a fan to generate each of a first cleaning airstream directed through the upper and lower sieves and a second cleaning airstream directed through the precleaning sieve, and
air pressure sensors located at a plurality of locations within the grain cleaning unit to sense air pressure at each of the plurality of locations and to generate signals indicative of the air pressure,
wherein a controller is configured to control operation of the fan to control the second airstream based upon the signals from the air pressure sensors and to control operation of the first actuator to adjust the position of the louvres of the precleaning sieve.

5. A combine harvester according to claim 4, wherein the controller is configured also to control operation of the second and third actuators to adjust the position of each of the upper and lower sieves based upon the signals from the air pressure sensors.

6. A combine harvester according to claim 5, wherein the controller is configured also to control operation of the one or more fans.
